(19) United States
(12) Patent Application Publication
(10) Pub. No.: US 2003/0059605 A1
(43) Pub. Date: Mar. 27, 2003

(54) Friction materials containing silicones for control of moisture sensitivity and noise generation

(76) Inventor: Sunil K. Kesavan, Troy, MI (US)

Correspondence Address: Honeywell International Inc., 101 Columbia Road, P.O. Box 2245, Morristown, NJ, 07962, US

(21) Appl. No.: 09/962,069

(22) Filed: Sep. 25, 2001

(51) Int. Cl. B32B 5/16

(52) U.S. Cl. 428/331; 428/447; 428/323; 428/325

(57) ABSTRACT

A friction material matrix is described which contains a silicone-containing material, such as but not limited to an organofunctional reactive silicone, and a binder system, the binder system physically or chemically binding the organofunctional reactive silicone. The organofunctional reactive silicone imparts water repellency to the friction material matrix. The organofunctional reactive silicone is preferably present in an amount of from about 0.5 to about 10 weight percent based on the total weight of the friction material matrix.

### FIELD OF THE INVENTION

The present invention relates generally to friction materials, and more particularly to friction materials containing silicones for the control of moisture sensitivity and noise generation.

### BACKGROUND OF THE INVENTION

Friction materials serve in a variety of ways to control the deceleration of a variety of vehicles and machines such as, but not limited to automobiles. In an automotive vehicle, one of the purposes of the friction members is to physically stop the vehicle. These units, including disk brake pads and rotors and brake shoes and drums, convert physical movement into frictional heat. Every wheel contains either a disk or brake drum assembly.

Friction members for brakes are typically made from materials that will produce friction with the rotor or drum and withstand the high temperatures developed during braking. One of the most common type of friction materials used in brakes and clutches for normal duty is generally termed organic. These organic friction materials usually contain about 30-40 weight % of organic components. One of the main constituents of practically all organic friction materials at one time was asbestos fiber, although small quantities of other fibrous reinforcement may have been used. Since asbestos alone did not offer all of the desired properties, other materials called property modifiers, either abrasive or nonabrasive, were added to provide desired amounts of friction, wear, fade, recovery, noise, and rotor compatibility. A resin binder, such as phenolic or cresylic resin, held the other materials together in a matrix. This binder was not completely inert and made contributions to the frictional characteristics of the composite. Because asbestos has been alleged to be the cause of certain health problems and is no longer environmentally acceptable, most modern brake pads and drum linings are made without asbestos. Thus, most current friction linings are made from synthetic and steel fibers, and iron, ceramic, and metallic powders.

One problem of significant concern that occurs with conventional friction materials is the increase in friction and/or noise generation in a wet/humid environment (normally referred to as moisture sensitivity), particularly for drum lining formulations. This can lead to sub-par performance of the braking system, as well as objectionable noises when braking, both of which lead to consumer dissatisfaction.

Therefore, there exists a need for a friction material composition that performs well in a high-moisture environment, without the generation of unsatisfactory levels of friction and/or noise.

### SUMMARY OF THE INVENTION

In accordance with a first embodiment of the present invention, a friction material matrix is provided, comprising: (1) at least one silicone-containing material; and (2) at least one binder system, the binder system physically or chemically binding the at least one silicone-containing material.

In accordance with a second embodiment of the present invention, a friction material matrix is provided, comprising: (1) at least one organofunctional reactive silicone; and (2) at least one binder system, the binder system physically or chemically binding the at least one organofunctional reactive silicone.

In accordance with a third embodiment of the present invention, an automotive braking element is provided, comprising: (1) at least one organofunctional reactive silicone; and (2) at least one binder system, the binder system physically or chemically binding the at least one organofunctional reactive silicone; wherein the at least one organofunctional reactive silicone imparts water repellency to the braking element.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### DETAILED DESCRIPTION OF THE INVENTION

The following description of the preferred embodiment(s) is merely exemplary in nature and is in no way intended to limit the invention, its application, or uses.

Friction materials useful in the practice of the invention may optionally contain one or more thermosetting resinous binders present in conventional amounts; reinforcing fibers present in conventional amounts; metal powders present in conventional amounts; lubricants, preferably solid, present in conventional amounts; abrasives present in conventional amounts; organic fillers present in conventional amounts; and inorganic fillers present in conventional amounts. Other materials may be added as well, as is known in the art.

As that term is used herein, “friction material matrix” means at least one silicone-containing material useful in the practice of the present invention, at least one binder system (e.g., phenolic resin), and optionally, additives such as, but not limited to, reinforcing fibers, metal powders, lubricants, abrasives, organic fillers, organic fillers, and the like.

The present invention proposes the use of silicone-containing materials, such as but not limited to organofunctional reactive silicones, especially in liquid form, in friction material matrixes in order to reduce moisture sensitivity.

In accordance with one embodiment of the present invention, liquid silicones, and more preferably liquid organofunctional reactive silicones, are incorporated into the friction material matrixes of disk and/or drum linings. The silicones of the present invention become part of transfer film formed at the interface of the friction couple. The water repellency of the silicones helps to eliminate, or at least reduce, moisture sensitivity, particularly in drum linings.

Silicone fluids such as but not limited to organofunctional dimethyl silicone, organofunctional alkyl silicone, organofunctional phenyl silicone, as well as other types of organofunctional reactive and non-reactive silicones can be incorporated into the friction formulations to eliminate and/or reduce moisture sensitivity. Organofunctional reactive silicones are highly preferred for their hydrophobicity, weatherability, chemical resistance and compatibility with the ingredients in conventional friction material matrix formulations. Organofunctional dimethyl silicone is readily commercially available from Sil-Tech Corporation (Adrian, Mich.).

The silicone liquid (or emulsion) can be incorporated into the friction material matrix during the mixing process. By way of a non-limiting example, low viscosity oils are preferred for incorporation into dry or semi-dry mixes. By way of another non-limiting example, high viscosity gums are preferred for their substantivity, easier handling and dispersion in wet or rubberized Banbury mixes. Alternately, the silicone can be either absorbed or adsorbed either into or onto one or more of the friction material matrix ingredients which are then incorporated into the formulation.

Preferred amount of silicone varies from about 0.5 weight percent up to about 10 weight percent of formulations, based on the total weight of the friction material matrix.

By way of a non-limiting example of an illustrative friction material matrix composition, in accordance with the general teachings of the present invention, reference is made to the Example, below:

### EXAMPLE

| | VOLUME PERCENT |
|---|---|
| | (based on the total volume of the |
| INGREDIENT | friction material matrix) |
| Styrene-butadiene rubber | 10 |
| Chlorobutyl rubber | 7 |
| Calcium sulfate | 9 |
| Vermiculite | 7 |
| Phenolic resin | 14 |
| Steel fiber | 5 |
| Coke | 3 |
| Graphite | 8 |
| Calcium hydroxide | 3 |
| Rockwool fiber | 8 |
| Friction dust | 16 |
| Organofunctional reactive epoxy | 1 |
| silicone fluid | |
| Zirconium oxide abrasive | 5 |
| Curatives | 4 |

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A friction material matrix, comprising:
at least one silicone-containing material; and
at least one binder system, the binder system physically or chemically binding the at least one silicone-containing material.

2. The invention in accordance with claim 1, wherein the at least one silicone-containing material imparts water repellency to the friction material matrix.

3. The invention in accordance with claim 1, wherein the at least one silicone-containing material is an organofunctional reactive silicone.

4. The invention in accordance with claim 3, wherein the organofunctional reactive silicone is selected from the group consisting of organofunctional dimethyl silicone, organofunctional alkyl silicone, organofunctional phenyl silicone, and combinations thereof.

5. The invention in accordance with claim 1, wherein the at least one silicone-containing material is present in an amount of from about 0.5 to about 10 weight percent based on the total weight of the friction material matrix.

6. A friction material matrix, comprising:
at least one organofunctional reactive silicone; and
at least one binder system, the binder system physically or chemically binding the at least one organofunctional reactive silicone.

7. The invention in accordance with claim 6, wherein the at least one organofunctional reactive silicone imparts water repellency to the friction material matrix.

8. The invention in accordance with claim 6, wherein the at least one organofunctional reactive silicone is present in an amount of from about 0.5 to about 10 weight percent based on the total weight of the friction material matrix.

9. The invention in accordance with claim 6, wherein the organofunctional reactive silicone is selected from the group consisting of organofunctional dimethyl silicone, organofunctional alkyl silicone, organofunctional phenyl silicone, and combinations thereof.

10. An automotive braking element, comprising:
at least one organofunctional reactive silicone; and
at least one binder system, the binder system physically or chemically binding the at least one organofunctional reactive silicone;
wherein the at least one organofunctional reactive silicone imparts water repellency to the braking element.
